(19) United States
(12) Patent Application Publication
(10) Pub. No.: US 2014/0376366 A1
(43) Pub. Date: Dec. 25, 2014

(54) IP MULTICAST LAYERED DISTRIBUTION METHOD AND SYSTEM

(71) Applicant: SHENZHEN SEWISE TECHNOLOGIES CO., LTD., Shenzhen, Guangdong (CN)

(72) Inventors: Hui Li, Shenzhen (CN); Yining Li, Shenzhen (CN); Changmin Chen, Shenzhen (CN); Jingbang Zhou, Shenzhen (CN); Huayu Zhang, Shenzhen (CN); Junqiu Feng, Shenzhen (CN); Yumeng Zhang, Shenzhen (CN); Hanxu Hou, Shenzhen (CN); Han Guo, Shenzhen (CN); Huiyao An, Shenzhen (CN)

(21) Appl. No.: 13/818,364

(22) PCT Filed: Feb. 22, 2012
(86) PCT No.: PCT/CN12/71482

§ 371 Date: Feb. 22, 2013

(51) Int. Cl. H04L 12/18; H04L 12/24; H04L 12/44; H04L 12/721

(52) U.S. Cl. CPC H04L 12/1886; H04L 12/185; H04L 45/124; H04L 41/12; H04L 12/44
USPC 370/230

(57) ABSTRACT

The present invention relates to IP network communication technology. It provides a kind of IP multicast data layer distribution method and system. The method includes: first code original multicast data into multiple sub-flow, separately specify different shunt sub-source for every sub-flow, distribute sub-group address, create sub-group state, etc, form shunt structure. Then the sink send join news to each shunt sub-source, join each shunt sub-source sub-group and become the leaf node of each sub-tree. And then each shunt sub-source determine the intermediate node according to the port receiving join news and construct multicast distribution-tree. If the overlapping portion between the multicast distribution trees produce congestion, in the congestion nodes network coding is used to eliminate congestion and construct coding sub-tree according to the way of building multicast distribution tree from the below of the coding nodes.

### FIELD OF THE INVENTION

The invention relates to the IP network communication technology, especially relates to an IP multicast hierarchical distributed method and system.

### BACKGROUND OF THE INVENTION

A kind of IP network communication is unicast, its characteristic is once the transmission of a message to a receiver; Another is broadcast, which transmit a message to all receivers once in the subnet. When the network have multiple receivers, unicast will lead to the same information with multiple copies in IP network, and repeat occupy network resources and server resources, so the transmission efficiency is low. But broadcast has no way to cover different subnet, otherwise will cause broadcast storm. Therefore, multicast transmission that is “transmitting a message to multiple receiver once” comes into being.

PIM-SM protocol namely Protocol Independent Multicast-Sparse Mode. PIM-SM protocol is the current recognition IP layer multicast protocols. The characteristic of PIM-SM are as follows:

1. Protocol independent. Namely the protocol using is independent of IP unicast. PIM-SM construct independent MRIB (Multicast Routing Information Base) to conduct the RPF (Reverse Path Forwarding) check.

2. Sparse mode, namely the transmission of data rely on the “Join-Pull” mechanism to explicitly establish tree distribution structure, rather than dense mode “Push-Prune” mechanism flooding type propagation, so it is more suitable for group of users in relatively sparse WAN range.

IGMP protocol namely Internet Group Management Protocol.

IGMP protocol is a communication protocol used to manage the Internet multicast group members. IGMP is a part of IP multicast standard applied between IP host and their DR (Designated Router), to support the temporary group address allocation and group members add to or delete; Also used to construct the multicast distribution tree structure between multicast router.

NC (Network Coding) is a kind of multicast network capacity of the technology, achieved through the relay node coding received information, is a new breakthrough in information transmission technology. Network coding endows information transmission theory with a new way of thinking, bit since then no longer be incompressible minimum transmission unit, in certain conditions, bit and bit can be encoded transmission, reduce transmission load caused by local bottleneck, therefore improve network transmission performance, reduce the average delay, increase the bandwidth, making communication approximation limit determined by network maximum flow theorem, and with security, robustness, and other performance improvement.

Multicast transmission mode is applied to requirement widely, such as triple-play broadcast TV system, audio-video point broadcast system, video conference system, the remote teaching system, real-time stock information delivery, interactive online game, etc. However the traditional multicast transmission system structure still cannot get large-scale commercial deployment after 30 years development, the main reason is the current multicast structure performance is unstable, bandwidth lesser, the quality of service QoS difficult to guarantee, lack of effective certification charging mechanism, unable to provide differential service for heterogeneous sink and so on. In 2000, the birth of network coding, originally is to improve the performance of multicast communication link, make full use of the link resources and multicast achieve maximum flow transmission. Network coding was born more than ten years so far, although many theoretical derivation and simulation verification try to prove that NC multicast can bring performance improvement, but still isn't applied in any practical multicast protocol. Therefore, the dispute for NC feasibility and effectiveness lasts more than ten years. A practical data distribution structure, in addition to the need for good theoretical performance, but also need to complete management strategy. Only the satisfactory agreement of users, operators, suppliers and management, can obtain the actual application. The combination of Network coding and multicast do not enough in this regard. On current NC multicast technology, the term “multicast” in most cases is more like “broadcast”. Because in the multicast frame, there is no design effective group management strategy, and multicast routing algorithm is difficult to operate. So, it can be said that the NC multicast model cannot support the dynamic Join/Prune operation, thus could not be practical.

Before the advent of network coding, the maximum flow transmission problem of multicast usually is resolved by finding the best multicast points sub-tree set method, namely the graph theory “Packing Steiner Trees” method. “Steiner Tree Problem” is that with the minimum total link length to connect the source and sink given. Steiner Tree problem and “Minimum Spanning Tree Problem” have their own characteristics. Spanning Tree don't allow more intermediate nodes, can only use a given node set; But Steiner Tree can increase pure Steiner Node to reduce the total length of the link. It is due to the existence of Steiner Node, making general Steiner Tree Problem is NP-Hard (non-deterministic polynomial-time hard) problem, unable to give an effective solution in polynomial time. The emergence of network coding make multicast maximum flow transmission problem can be transformed into linear programming problem or convex optimization problem, and thus be able to design a polynomial time algorithm to achieve maximum flow multicast.

Network coding multicast implementation generally can be summed up in two steps: 1, the structure of the coding subgraph. 2, the determination of decoding scheme. Coding subgraph is refers to the collection of whole Stan's collection trees in multicast communication, including source, sink and other nodes participating in multicast transmission and link. So the subgraph construction coding algorithm is the multicast routing algorithm.

In the current technology, usually adopting centralized algorithm code subgraph structure, which does not support composition members to join and leave dynamically. And decoding scheme is “facing group (Packet-Oriented)” of “Random linear code (RLNC)” in common. These network coding schemes are difficult to practical for the pursuit of good theoretical performance leads to ignore the actual network conditions and management details.

In conclusion, the existing technology solutions can't effectively support group dynamic join/leave, and throughput and transmission performance is low and can't provide a hierarchical QOS guarantee to support user isomerism.

### SUMMARY OF THE INVENTION

The present invention provide an IP multicast data layer distribution method or system, in order to resolve the current technical solution questions that ether can't effectively support group to dynamic join/leave, or throughput and transmission performance is low and can't provide a hierarchical QOS guarantee to support user isomerism.

### BRIEF DESCRIPTION OF THE DRAWINGS

FIG. 1 illustrates IP multicast data distribution structure schematic diagram of present invention;

FIG. 2 illustrates the flow chart of the IP multicast data layer distribution method about the implementation examples 1 and 2;

FIG. 3 illustrates the schematic diagram of the representation of coding all packets in sub-flow CSF about the implementation example 2;

FIG. 4 illustrates the schematic diagram of data flow transmission from source to sink when IPMF communication about the implementation example 2; and

FIG. 5 illustrates is the structure schematic diagram of IP multicast layer distribution system about the invention implementation example 3 and 4.

### DETAILED DESCRIPTION OF THE PREFERRED EMBODIMENTS

On the one hand, the solution of present invention provide an IP multicast data layer distribution methods, including:

Source router receives the source server S sends the multicast group G original multicast data flow and establish (G, S) group of state entry;

Coding original multicast data flow for N sub-flows, the integrated information quantity of these N sub-flows is equal to the mentioned original multicast flow, and sink receiving N sub-flows of a subset can reconstruct part of the original multicast flow and obtain certain quality service;

Make sure N shunt sub-source for mentioned N sub-flow which is different from sink;

Multicast shunt sub-source information to auxiliary group G′, the shunt sub-source information including multicast group address, source server address, shunt sub-source numbers, shunt sub-source address, shunt sub-source sub-groups address, shunt sub-source coding coefficient matrix;

N sub-flows are sent to the shunt sub-source in parallel unicast way, the mentioned source server S and the shunt sub-source compose multicast data distribution structure of the shunt structure;

After each shunt sub-source receive first sub-flow of source router, create sub-group state and become the root node of each sub-tree;

Transmit the received sub-flow to the corresponding port in the output port list of sub-group state, if the port is empty, sub-source send pruning news to the sub-flow input port;

When the sink need to join a multicast group G, send join news to the auxiliary group gathering node RP, in order to listen to auxiliary group G′news and get each shunt sub-source information;

Send a join message to the corresponding shunt sub-source in accordance with shunt sub-source information, join the corresponding the sub-group of shunt sub-source, become the leaf nodes of the corresponding sub-tree;

Each node according to the receiving join news determine the downstream node in each sub-tree, make sure the port of sending join news according to the reverse shortest path, thereby determine its upstream node in each sub-tree, which can determine the various intermediate node of the sub-tree, multicast distribution trees composed by each shunt sub-source, the intermediate node of each sub-tree and each sub-tree new leaf nodes, the multicast forest structure of multicast data distribution structure composed by each multicast distribution tree;

If the overlapping portion between the multicast distribution trees produce congestion, when multicast distribution trees producing congestion in the downstream of congestion nodes have the same leaf nodes, in the congestion nodes network coding used to eliminate congestion and construct coding sub-tree according to the way of building multicast distribution tree from the below of the coding nodes regarding as the root node of coding sub-tree;

Each shunt sub-source transmit each sub-flow to sink according to the path of each node in multicast forest structure.

On the other hand, the solution provides an IP multicast layer distribution system, the system including the source server, source router, shunt sub-source, intermediate nodes and sink;

The source router include:

Set of state build unit, used for receiving the multicast group G original multicast flow sent by the source server S and establishing the (G, S) group state;

Sub-flow generation unit, used for coding original multicast flow for N sub-flows, the integrated information quantity of these N sub-flows is equal to the mentioned original multicast flow, and sink receiving N sub-flows of a subset can reconstruct part of the original multicast flow and obtain certain quality service.

Shunt sub-source determining unit, used for making sure N shunt sub-source for mentioned N sub-flow which is different from sink;

Sub-source multicast unit, used to multicast shunt sub-source information to auxiliary group G′, the shunt sub-source information including multicast group address, source server address, shunt sub-source numbers, shunt sub-source address, shunt sub-source sub-groups address, shunt sub-source coding coefficient matrix;

Sub-flow send unit, used for N sub-flows sent to the shunt sub-source in parallel unicast way, the mentioned source server and the shunt sub-source compose multicast distribution structure of the shunt structure;

The sink include:

Sub-source information acquisition unit, used to send join news to the auxiliary group gathering node RP when the sink need to join a multicast group G, in order to listen to auxiliary group G′ news and get each shunt sub-source information;

Leaf node establishing unit, used for sending a join message to the corresponding shunt sub-source in accordance with shunt sub-source information, join the corresponding the sub-group of shunt sub-source, become the leaf nodes of the corresponding sub-tree;

The shunt sub-source include:

Root node establishing unit, used to create sub-group state and become the root node of each sub-tree after each shunt sub-source receive first sub-flow of source router;

Sub-flow retransmission unit, used for transmitting the received sub-flow to the corresponding port in the output port list of sub-group state, if the port is empty, sub-source send pruning news to the sub-flow input port;

Intermediate node determining unit, used to determine the downstream node in each sub-tree according to the receiving join news, make sure the port of sending join news according to the reverse shortest path, thereby determine its upstream node in each sub-tree, which can determine the various intermediate node of the sub-tree;

Sub-flow transmission unit, used to transmit each sub-flow to sink according to the path of each node in multicast forest structure, multicast distribution trees composed by each shunt sub-source, the intermediate node of each sub-tree and each sub-tree new leaf nodes, the multicast forest structure of multicast data distribution structure composed by each multicast distribution tree.

In the implementation examples of the present invention, first the source router separate/recode original multicast data into multiple sub-flow through the source router, separately specify different shunt sub-source, distribute sub-group address, create sub-group state for every sub-flow, etc., formatting of multicast data distribution structure of the shunt structure which creates conditions for the sub-flow independent multipath parallel transmission, then the sink send join news to each shunt sub-source, join each shunt sub-source sub-group and become the new leaf node of each sub-tree, and then each shunt sub-source determine the intermediate node according to the reception of join news port, finally multicast distribution trees composed by each shunt sub-source, the intermediate node of each sub-tree and each sub-tree new leaf nodes, the multicast forest structure of multicast data distribution structure composed by each multicast distribution tree, so each sub-source can transmit each sub-flow to sink according to each node path in multicast forest. The multiple multicast sub-tree of multicast forest structure parallel transmit sub-flow to different sink, can get higher bandwidth and better stability than traditional multicast tree structure. In addition, the original data flow stratified according to priority, different levels of sub-flow is transmitted by different sub-tree. Layered transmission structure will provide better QoS and provide support for the isomerism users, expanding the application scope of the traditional multicast.

In order to make the purpose of the present invention, the technical scheme and advantages more apparent, the present invention will be described in further details combined with the following combination figures and implementation examples. It should be understood that the concrete implementation examples described here are only used to explain the present invention, not intended to limit the invention.

In the implementation examples of the present invention, first the source router separate/recode original multicast data into multiple sub-flow through the source router, separately specify different shunt sub-source, distribute sub-group address, create sub-group state for every sub-flow, etc., formatting of multicast data distribution structure of the shunt structure which creates conditions for the sub-flow independent multipath parallel transmission. Then the sink send join news to each shunt sub-source, join each shunt sub-source sub-group and become the new leaf node of each sub-tree. And then each shunt sub-source determine the intermediate node according to the reception of join news port. Finally multicast distribution trees composed by each shunt sub-source, the intermediate node of each sub-tree and each sub-tree new leaf nodes, the multicast forest structure of multicast data distribution structure composed by each multicast distribution tree. So each sub-source can transmit each sub-flow to sink according to each node path in multicast forest.

The basic framework of IPMF (IP Multicast Forest) will be described firstly in order to explain implement examples better.

The main advantages of IPMF are:

1. The multipath “Forest Type” data distribution structure of multiple multicast sub-trees parallel transmission. The multicast forest structure can get higher bandwidth and better stability than traditional multicast tree structure.

2. The original data flow stratified according to priority, different levels of sub-flow is transmitted by different sub-tree. Layered transmission structure will provide better QoS and provide support for the isomerism users, expanding the application scope of the traditional multicast.

3. The application of network coding solution between sub-flows can solve the bottleneck problem due to collision. Coding can eliminate the obstructive influence produced by local bottleneck for “the whole route”, as long as the appropriate coding strategy, can correctly decode the original information at the receiving port.

4. Introducing the concept of “auxiliary group” used to control the distribution of information.

The basic framework of IPMF described as follows:

The core idea of IPMF is “shunt autonomy”. Original multicast stream in accordance with the importance of data content at the source are split or recoded into multiple sub-flow with hierarchical relationships. Each sub-flow corresponds to sub-source node which is different from source node, this is “split”. Each sub-flow has the relative independent subgroup address, distribution tree and group management mechanism based on Internet Group Management Protocol (IGMP), and intermediate router establish relatively independent group forward entrance (entry) for each subgroup, this is “autonomy”. All the sub-flow distribution trees constitute the IPMF multicast forest structure. Multicast user only need to “collect” all sub-flow, can reconstruct the original multicast stream. As long as streaming and encoding algorithm are designed reasonably, even if the multicast users can only collect part of the sub-flow because of their own limitation or network restriction, can still reconstruct the original multicast stream and enjoy a certain quality of service.

IPMF is the expansion of traditional multicast tree-like structure, combines the “pure routing” strategy and “network coding”, it inherits the convenient group member management of the distribution tree and the manipuility in router choice, while expanding its transmission performance and solving collision problem by network coding.

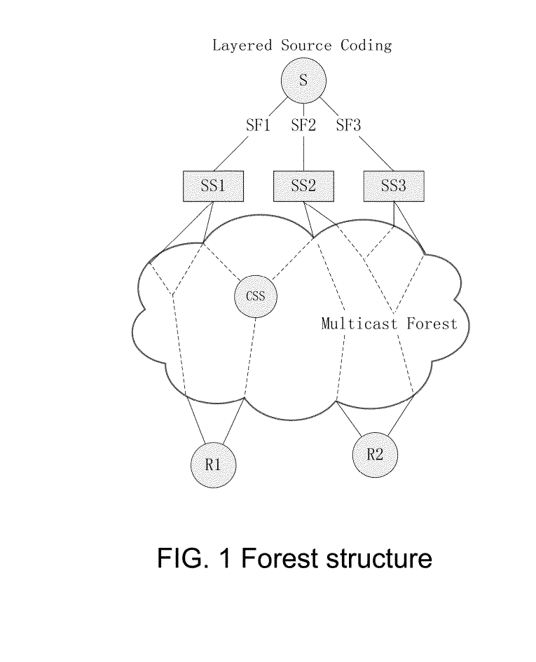

There are five kinds of node in IPMF: source, shunt sub-source, coding sub-source, routing node and sink. The whole IP multicast distribution structure can be divided into two pieces of structure: “diversion structure” and “multicast forest structure”. The shunt structure including source and sub-source. While multicast forest structure by sub-source, coding node, routing nodes and sink. Specific configuration schematically shown in FIG. 1, in this figure, the source S, the sub-source including SS1, SS2 and SS3, including source for S and sub-source composition multicast data distribution structure of the shunt structure, intermediate node including coding node CSS and routing node which compose the multicast forest structure based on the multicast distribution structure.

The main function of the shunt structure is to split the original multicast flow into sub-flows. Original multicast stream in accordance with the importance of data content at the source are split or recoded into multiple sub-flow. The present invention does not consider the hierarchical algorithm, can consult SVC (Scalable Video Coding) design concept. The basic idea of the present invention is, we can split out the most basic, most important data, and recode to form a “base sub-flow”. Other data are split and recoded, according to their importance, into “enhancement sub-flows”. Group receivers, who can only collect a few sub-flows due to heterogeneity, will be able to enjoy the service in a lower quality, if the “base sub-flow” is collectable.

Definition 1 Sub-flow (SF): In IPMF, a sub-flow is a data flow, formed by splitting and recoding the original multicast flow at the source node. According to the transmission demand and the resource constraint, an original multicast flow can be split into as many as needed, if the following statements are satisfied:

1. The integrated information quantity of all sub-flows is exactly equal to the information quantity of the original multicast flow. That is to say, sub-flows will not carry new information that the original multicast flow didn't have.

2. The group address and the group entry of a sub-flow are independent from those of the other sub-flows.

3. The group address and the group entry of a sub-flow have the same prefix with the original multicast flow. Thus a mask mechanism can be applied in routers to deal with sub-flows that are from different original multicast flows.

4. Sub-flows from the same original multicast flow have the same group member.

After splitting, the source node will assign a sub-source node to each sub-flow, then, transmit the sub-flow to the assigned sub-source node in a unicast manner.

Definition 2 Sub-source (SS): In IPMF, sub-source node is a node in the current AS, that is different from source node and group receiver. One sub-source is assigned to one sub-flow. The sub-source assignment can be done by administrative configuration, also can through the “election” produce mechanism.

Sub-source nodes are important components in IPMF that connect the layered source coding part and the multicast forest part. A sub-source node will carry out the following functions:

1. Receiving and caching sub-flow information packets.

2. Acting as a new source in the current AS, including constructing the tree-like multicast distribution structure, managing group members, and sending data out to the output interface list.

Note that a sub-source is subject to its source node. The sub-source functionality on a node is activated only when configured so, and will be deactivated when the original multicast session ends. That is to say, The sub-source function of an intermediate nodes only when configured enabled will work normally, and when the original multicast session ended, the sub-source function will stop working for.

By assigning different sub-source nodes to different sub-flows, information with different priorities is able to be transmitted on different distribution structures, thus traveling on different physical paths. This layered multi-path structure produces higher transmission throughput and robustness.

Multicast forest part forms the main content distribution structure of IPMF. The multicast forest part can be seen as multiple independent multicast distribution trees, each transmitting a sub-flow to the same receiver group concurrently. It is not hard to see that compared with a single distribution tree (like PIM-SM) a multicast forest surely can produce a wider transmission bandwidth. The difference of Packing Steiner Trees whose final results is to construct a multicast forest structure is, simple Packing must use complex, centralized optimization algorithm to avoid local link bottleneck, or it will greatly reduce the network performance. The multicast forest structure of IPMF uses network coding strategy directly to eliminate the influence of the bottleneck.

Definition 3 Sub-tree (ST): In IPMF, a sub-tree is the multicast distribution tree constructed by a sub-source node, using IGMP join/prune messages. Every sub-tree corresponds to the only sub-flow and sub-source. Consisting of intermediate nodes and links, a sub-tree connects a sub-source and its group receivers with a single path, where the corresponding sub-flow is transmitted on. All the sub-trees that belong to the original multicast session form a so-called coding-sub-graph of IPMF.

Relatively independent sub-tree parallel transmission will meet collision and bottleneck problem. According to former researches, network coding is capable of transform this NP-Complete problem into “overlapping packing of flows”, which is Linear (Convex) Program problem dropping complexity greatly. There are many good optimization algorithms proposed by former papers. Most of them approach this problem from an administrative prospect, thus hard to operate by individual routers and hosts. In IPMF, we propose a user demand adaptive algorithm to deal with sub-tree collision.

When coding happens because of sub-tree collision, current group receivers, as well as potential receivers might want to be notified of this change. Besides, the coding operation might need additional management resources. For the reasons above, in IPMF, intermediate node will start “coding-sub-source” function when in need.

Definition 4 Coding-sub-source (CSS): In IPMF, a coding-sub-source sits on the node that carries out coding operations. In most cases, a coding-sub-source acts just like other independent sub-sources, but still, there are differences:

1. A coding-sub-source receives information from its parent sub-flows, not a single sub-flow from the original multicast source.

2. Multiple coding-sub-sources may sit on one physical coding node.

3. If a coding-sub-flow has k parent sub-flows, then, when a group receiver collects sub-flows, the coding-sub-flow can replace any one of its parent sub-flows, only when the “sub-flow coefficient matrix” of that receiver is reversible after the replacement.

4. When a coding-sub-source emerges, it will send an inform message to the source node to register itself, and notify the source node about its coding coefficient vector. It will also send a message through all its registered output interfaces to inform downstream nodes about the change.

Now we have the coding-sub-source, along with the associated coding-sub-flow, and coding-sub-tree. Group receivers can collect the coding-sub-flow to gain information if certain conditions are satisfied. But how do we inform group receivers? We know that in traditional PIM-SM multicast protocal, a group receiver sends (*, G) RPT join toward the RP (Rendezvous Point) node, if it doesn't know where the source is. In IPMF, we introduce an auxiliary group to do the job.

Definition 5 Auxiliary group (AG): In IPMF, an AG adopts the traditional PIM tree-like multicast distribution structure, is the only ad-ministration information multicast group in an AS, that has a fixed and public group address and RP address.

Every multicast source in the current AS must publish administration information through AG periodically, during its active time.

Every group receiver in the current AS must listen to AG for necessary information periodically, during its active time.

Auxiliary group is a highly flexible component that can transmit many kind of information. For now, we use AG to multicast following information to all group receivers and potential receivers:

1. Active groups and its sources in the current AS, including group address and source address.

2. Sub-source addresses, sub-group addresses, coding-sub-source addresses, coding-sub-group addresses of every active group.

3. Distribute sub-flow coefficient matrix.

Since AG is basically used for multicasting administration information, it is predictable that the bit rate of an AG multicast flow is low. Thus in IPMF, we adopt a traditional RPT structure for AG. Simulation results show that AG works well in doing its job.

### Implementation Example 1

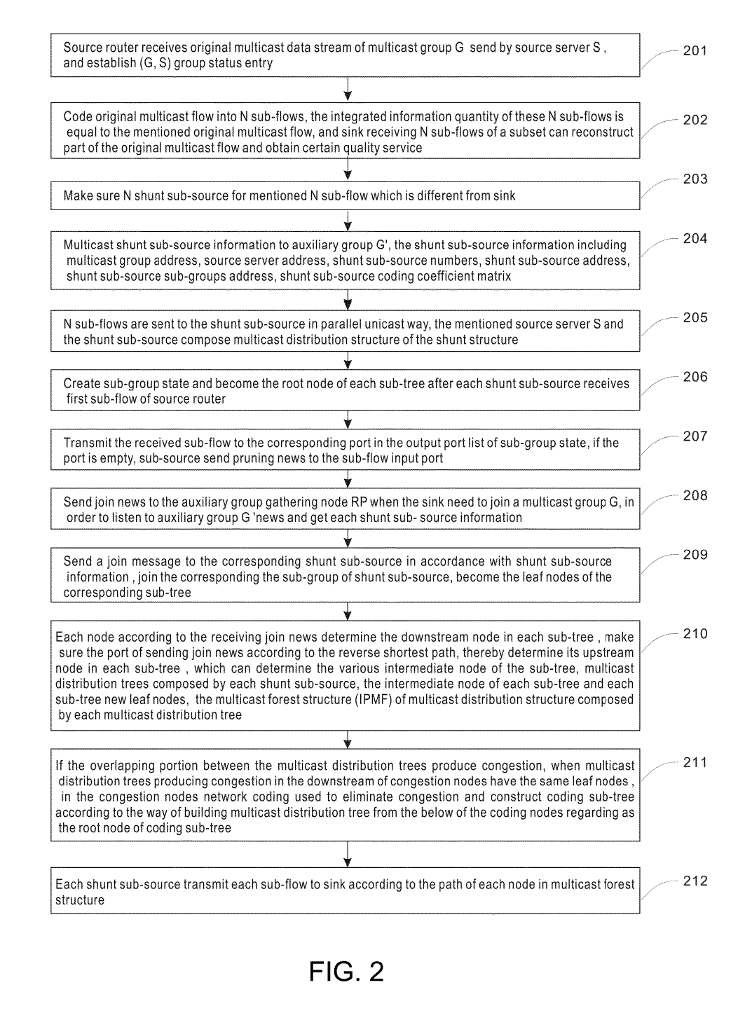

From the FIG. 2, we can know the implementing process of the present invention example 1 for IP multicast data layer distribution method. The method can be applied to IP multicast data layer distribution system including source server, source router, sub-source, intermediate node and sink. Here the intermediate node is located in the route between sub-source and sink, details as follows:

201. Source router receives original multicast data stream of multicast group G send by source server S, and establish (G, S) group status entry.

In this example, the active source server S, generates a original multicast data flow at rate of 2 multicast group G, and the flow is sent to the adjacent source router. Source router create group status entry (G, S) for the group G and the source server S, and set the input port receiving the original multicast data stream to incoming interface for (G, S).

202. Code original multicast flow into N sub-flows, the integrated information quantity of these N sub-flows is equal to the mentioned original multicast flow, and sink receiving N sub-flows of a subset can reconstruct part of the original multicast flow and obtain certain quality service.

In this example, the source router divides the original multicast data stream into base layer and the enhancement layer for sub-flow SF1 and SF2, the sub-low rate are 1, the integrated information quantity of the 2 sub-flows is equal to the original multicast flow.

203. Make sure N shunt sub-source for mentioned N sub-flow which is different from sink.

In this example, the source router appoint two shunt sub-source SS1, SS2 as two shunt sub-source through the manual static configuration. Of course that can also through the dynamic election way to determine the shunt sub-source, the election means are similar to the PIM bootstrap mechanism. The static configuration need to understand the number of sub-source and the address information of shunt sub-source configured by the global topological structure's administrator before starting the multicast session. Dynamic electoral methods may pick out the best sub-source according to the connectivity of the node to the sink. The present invention implementing cases don't limit the designating process for shunt sub-source.

204. Multicast shunt sub-source information to auxiliary group G′, the shunt sub-source information including multicast group address, source server address, shunt sub-source numbers, shunt sub-source address, shunt sub-source sub-groups address, shunt sub-source coding coefficient matrix.

In this example, the source router send the shunt sub-source information to auxiliary group G′, the mentioned shunt sub-source information including multicast group address, source server address, shunt sub-source numbers, shunt sub-source address, shunt sub-source sub-groups address, shunt sub-source coding coefficient matrix. The initial coding coefficient matrix CM is a 2×2 unit matrix.

205. N sub-flows are sent to the shunt sub-source in parallel unicast way, the mentioned source server S and the shunt sub-source compose multicast distribution structure of the shunt structure.

The source router will respectively send base layer and enhancement layer to SS1 and SS2 in the unicast way, SS1 and SS2 is not created the corresponding group state and subgroup state, the mentioned source server S and the shunt sub-source SS1 and SS2 compose multicast distribution structure of the shunt structure.

206. Create sub-group state and become the root node of each sub-tree after each shunt sub-source receives first sub-flow of source router.

In this example, SS1 and SS2 create the corresponding set of state and subgroup state after receiving the first sub-flow packets, but don't forward this packet, because the output port list in the subgroup state is empty. For example, the shunt sub-source SS2, after receiving the first sub-flow packets to itself create the state of the sub-group (G, S|SS2), and set the packets port for (G, S|SS2) incoming interface. The implementation case describes shunt process only treating sub-flow SF2 as an example, which is similar to SF1 operation.

207. Transmit the received sub-flow to the corresponding port in the output port list of sub-group state, if the port is empty, sub-source send pruning news to the sub-flow input port.

In this example, SS2 check the subgroup (G, S|SS2) output interface list, If it isn't empty, forwards the mentioned sub-flow to the output interface, if empty, then discards the sub-flow and sends prune news to input interface.

208. Send join news to the auxiliary group gathering node RP when the sink need to join a multicast group G, in order to listen to auxiliary group G′ news and get each shunt sub-source information.

The auxiliary group G′ uses traditional PIM tree-type multicast distribution structure, holds the only public group address and the only public gathering node RP in the autonomous domain.

209. Send a join message to the corresponding shunt sub-source in accordance with shunt sub-source information, join the corresponding the sub-group of shunt sub-source, become the leaf nodes of the corresponding sub-tree.

Before the sink according to above mentioned shunt sub-source send join news to the corresponding shunt sub-source, further including the following steps:

When the sink monitor that in auxiliary group the shunt sub-source coding coefficient matrix is unit matrix, the network doesn't encode sub-source. In order to get mentioned forwarding sub-flow optimal port, uses the shunt sub-source address to lookup routing table. The optimal port is got through the reverse shortest path method, which is a routing algorithm in essence. The algorithm is run when sink monitor that the CM of auxiliary group news is unit matrix, namely the sub-source does not exist coding sub-source.

Among them, each blade sub-flow is associated with a coding coefficient vector CV, which is used to represent the sub-flow “component”.

The uncoded original sub-flows, the CV is unit vector; The first sub-flow and the second sub-flow are coded into the first coding sub-flow CV [α, β, 0 . . . , 0], the α and the β are respectively the coding coefficient of the first sub-flow and the second sub-flow.

The coding coefficient is chosen randomly from GF (2 n). A participating coding sub-flow is corresponded to a coding coefficient, namely the all packets of sub-flow use the code coefficient for coding, only in this way the coding sub-flow are expressed the sum of the upstream sub-flow components;

All code coefficient vector ordered according to the sub-flow number which constitute coding coefficient matrix CM generated by the original source and transmitted through the auxiliary group. Sink get CM from listening to auxiliary group, operate IMF multicast routing algorithm, then decide which subgroup is joined in order to get the sub-flow.

That getting port process through the reverse shortest path method is a dynamic construction process of multicast forest structure. This situation applied at the beginning of the multicast session. At this time, there is no coding-sub-source in the network, thus the CM an initial group receiver gets from the auxiliary group is simply a N×N unit matrix:

$${CM}_{init} = ( \begin{matrix}1 & 0 & 0 & … & 0 \\ 0 & 1 & 0 & … & 0 \\ 0 & 0 & 1 & … & 0 \\ ⋮ & ⋮ & ⋮ & ⋱ & ⋮ \\ 0 & 0 & 0 & … & 1\end{matrix} )$$

This example shows the basic idea of routing algorithms and first presents routing algorithms based on a simplified conditions, but doesn't limit the invention.

In the example, we need to state a few simplified conditions:

1. A node will operate NC, only when multiple incoming sub-flows share the same output interface, and the overall bandwidth of these incoming sub-flows exceeds the effective bandwidth of the output interface.

2. Assume all sub-flows are equally split that they have the same bandwidth. Assume all physical links in the network have the same bandwidth, and the bandwidth of a link is not larger than twice the bandwidth of a sub-flow. That means two sub-flows cannot be transmitted through one link at the same time.

3. In the following discussion, we first discuss that the original source are split into two sub-flow situation.

The IPMF initial routing algorithm based on above simplified conditions are:

```
1: for (each receiver)
2:  { Listen to the auxiliary group and update the CM;
      //First distribute port for each sub-flow according to the priority
3:  for (each sub-flow, higher priority first )
4:  { int i = 1; // I means the ith best path. For example I = 1 mean
              the optimal path.
5:  while ( i )
6:  {  if ( there are still un-occupied interfaces)
7:  {Lookup the corresponding sub-source address in the
              routing table, with the ith best path
8:  if (the returned interface in un-occupied)
9:  Occupy the interface( occupy but nonuse)
10:  else  //  current sub - flow required occupied by other
                        higher priority sub - flow
11:  if ( i < the number of interfaces)
12:  {  i+ +;
13:  CONTINUE;}
14:  else  BREAK;  // all ports have been distributed
15:  }
16:  }
17:  else
18:  BREAK;
19:  }
20:  } //Send ICMP Join, construct multicast
                  distribution structure
21:  for ( all sub-flows that have occupied an interface)
22:  {
23:  Send Source-Specific-Join with the occupied interface
24:  }
25:  }
```

The above algorithm try its best to distribute different port for different sub-flow that receives each sub-flow.

210. Each node according to the receiving join news determine the downstream node in each sub-tree, make sure the port of sending join news according to the reverse shortest path, thereby determine its upstream node in each sub-tree, which can determine the various intermediate node of the sub-tree, multicast distribution trees composed by each shunt sub-source, the intermediate node of each sub-tree and each sub-tree new leaf nodes, the multicast forest structure (IPMF) of multicast distribution structure composed by each multicast distribution tree.

In this example, if the intermediate nodes receiving Join news already exists corresponding subgroups state, it is stated that intermediate nodes have belonged to a part of the sub-tree described and will join the port receiving Join news in the output port list of the corresponding subgroup state, and create a new branches for the sub-tree;

The intermediate nodes receiving Join news create subgroups state if without corresponding subgroup state. The port receiving to Join news is joined in the output port list of the corresponding subgroup state and transmits the Join news according to the corresponding shunt sub-source direction. Until the Join message arrives the intermediate node or shunt sub-source that already exist in the corresponding subgroup state, the above mentioned intermediate node or shunt sub-source put the port receiving join news into the output port list of the corresponding subgroup state, then complete graft.

Each shunt sub-source according to the port in the output port list can determine each sub-tree's intermediate node.

211. If the overlapping portion between the multicast distribution trees produce congestion, when multicast distribution trees producing congestion in the downstream of congestion nodes have the same leaf nodes, in the congestion nodes network coding used to eliminate congestion and construct coding sub-tree according to the way of building multicast distribution tree from the below of the coding nodes regarding as the root node of coding sub-tree;

212. Each shunt sub-source transmit each sub-flow to sink according to the path of each node in multicast forest structure.

In the implementation examples of the present invention, first the source router separate/recode original multicast data into multiple sub-flow through the source router, separately specify different shunt sub-source, distribute sub-group address, create sub-group state for every sub-flow, etc., formatting of multicast data distribution structure of the shunt structure which creates conditions for the sub-flow independent multipath parallel transmission. Then the sink send join news to each shunt sub-source, join each shunt sub-source sub-group and become the new leaf node of each sub-tree, and then each shunt sub-source determine the intermediate node according to the reception of join news port. Finally multicast distribution trees composed by each shunt sub-source, the intermediate node of each sub-tree and each sub-tree new leaf nodes, the multicast forest structure of multicast data distribution structure composed by each multicast distribution tree, so each sub-source can transmit each sub-flow to sink according to each node path in multicast forest. The multiple multicast sub-tree of multicast forest structure parallelly transmit sub-flow to different sink, can get higher bandwidth and better stability than traditional multicast tree structure. In addition, the original data flow stratified according to priority, different levels of sub-flow is transmitted by different sub-tree. Layered transmission structure will provide better QoS and provide support for the isomerism users, expanding the application scope of the traditional multicast.

### Implementation Example 2

The present invention implementation example 2 shows the realization process of IP multicast layer distribution method that is same with the example 1. The difference between them is that, in this example, when the sub-flow passing into the two sub-source collide, some intermediate node become coding sub-source. The implementation case mainly detailed after sink according to the mentioned shunt sub-source send join news to the corresponding shunt sub-source send, when the two sub-flow receiving news occur a collision, the above two sub-flow are made network code, and then how to determine the intermediate nodes between the source server and sink, as detailed below:

If different join news sent by sink to different shunt sub-source through the same link reach the intersection node, and the above two sub-flow sum of bandwidth is greater than the effective bandwidth of the stated output port, thus turn on the intersection node's coding sub-source function, make the above two sub-flow network code, the specific process of network coding is:

The intersection node address is informed to source router in the way of unicast;

After receiving intersection node address, source router in a limited field generates two random coding coefficient for two sub-flow which form a coding coefficient vector sent to intersection node in unicast way, so as to make the intersection node activate coding sub-source function. The source router between coding coefficient vector generated by different intersection nodes, and meet linear independence between two vectors;

Put sub-flow data packet into coding cache in which the public capacity is greater than two packet length;

Count the interval between the two sub-flow packet real-time respectively, referred to as the first sub-flow packet interval and the second sub-flow packet interval, selecting the smaller recorded as coding flow packet interval which is used to set coding output timer;

If the timer is overtime, we check the coding cache, if it stores two sub-flow packets which is two sub-flow data packet, it will be coded for coding the sub-flow packets according to the coding coefficient vector, and forward to the corresponding output port;

Recount the code flow packet interval and reset the coding output timer, turn on the coding sub-source function of the intersection node.

Optionally, count the interval between the two sub-flow packet real-time respectively, referred to as the first sub-flow packet interval and the second sub-flow packet interval, selecting the smaller recorded as coding flow packet interval which is used to set coding output timer, also including:

If the timer is overtime, we check the coding cache, if in it, there are two sub-flow packets that are from the same sub-flow, the first receiving sub-flow packet will be forwarded directly.

If the code cache only has a flow packet, it will be forwarded directly.

Recount the code flow packet interval and reset the coding output timer.

Optionally, count the interval between the two sub-flow packet real-time respectively, referred to as the first sub-flow packet interval and the second sub-flow packet interval, selecting the smaller recorded as coding flow packet interval which is used to set coding output timer, also including:

If the timer is overtime, we check the coding cache, if in it, there is not sub-flow packet, reset coding output timer according to the coding flow packet interval calculated in last successful coding or forwarding.

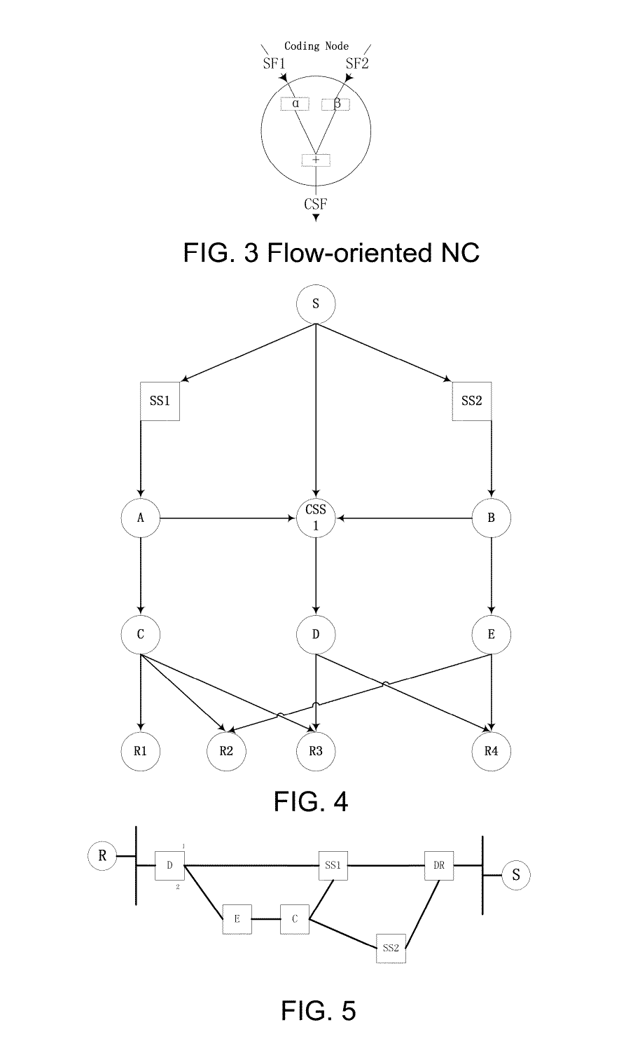

This procedure shows different sink nodes Join news are sent, when occurs collisions, the colliding node is activated for the coding sub-source. That is to say, the NC strategy of IPMF, as well as the constructing process of coding sub-source, encoding sub-flow. IPMF uses a flow-oriented linear NC strategy. Flow-oriented is that sub-flow is treated as the smallest unit in IPMF NC strategy, not individual packets. There are the most significant differences between “packet-oriented” and “flow-oriented” NC strategy, for the “flow-oriented”, coding coefficient is chosen for the whole sub-flow, not for each packet separately. For example. In FIG. 3, if we chose α and β as coefficients for sub-flow SF1 and SF2, then all the packets in the coding-sub-flow CSF can be calculated as:

Packet_{CSF}=α×Packet_{SF1}β×Packet_{SF2}

Note that, although specific coding operation still adopt pack as the unit, the choice of coding strategy only pay attention to the sub-flow. The linear network coding strategy of “flow-oriented” has the following advantages:

1. Provide administrative convenience. Obviously, flows are easier to manage than individual packets. The sub-flow can be tracked and monitored and statistics, but the ubiquitous packet in the network is difficult to unified tracking management.

2. Provide basis for routing, and decoding. A “packet-oriented” coding strategy can hardly reflect the relationship between packets. It doesn't care about the content priority, as well as the path traveled. That is to say, the “packet-oriented” random linear network coding completely abandons router. A group receiver cannot decide what information to receive initiatively, but can only passively receive all the arrived packets in a multicast session. A receiver cannot determine what quality of service he can get, before he really gets it. A receiver is unable to keep the service quality after he gets it. The “packet-oriented” strategy is lack of management, although can reach better statistical transmission performance by the fully mixed characteristics, but it is difficult to guarantee the user experience;

3. Reduce the size of the satisfactory Galois Field. Obviously, the size of the satisfactory Galois Field for each sub-flow choosing random number intra-domain is far less than that for each packet.

In IPMF, each sub-flow including coding-sub-flow is associated with a coefficient vector (CV):

CV=[c₁,c₂ . . . ,c_{N}]^{T}

Where N is the number of sub-flows, including coding-sub-flows, and cᵢ, 1≦i≦N, is the coefficient number randomly chosen from GF (2^{p}). If we associate a sub-flow number from 1 to N to each sub-flow, then the CV of a sub-flow generally described its composition. For example, and the CV of sub-flow SF1 is CV_{SF1}=[1,0,0,0]^{T}, the CV of sub-flow SF2 is CV_{SF2}=[0,1,0,0]^{T} in FIG. 3, the CV for CSF is CV_{CSF}=[α,β,0,0]^{T}.

We use these CVs to form a coefficient matrix (CM), which is formed and maintained by source, then multicast the CM through auxiliary group. We assume at a certain time, there are M CSSs in the network. So we can form a coefficient matrix in the source node as follows:

$$CM = ( \begin{matrix}1 & 0 & 0 & … & 0 & \vert & {α}_{11} & {α}_{21} & … & {α}_{M 1} \\ 0 & 1 & 0 & … & 0 & \vert & {α}_{12} & {α}_{22} & … & {α}_{M 2} \\ 0 & 0 & 1 & … & 0 & \vert & {α}_{13} & {α}_{23} & … & {α}_{M 3} \\ ⋮ & ⋮ & ⋮ & ⋱ & ⋮ & \vert & ⋮ & ⋮ & ⋱ & ⋮ \\ 0 & 0 & 0 & 0 & 1 & \vert & {α}_{1 N} & {α}_{2 N} & … & {α}_{MN}\end{matrix} )$$

As we can see, the first part of the CM is a N×N unit matrix, representing N sub-flows. The second part of CM is a N×M matrix, representing M coding-sub-flows.

When a group receiver collects one sub-flow, it collects one column of the CM. When a group receiver collects N sub-flows, including coding-sub-flows, it collects a matrix, called the receiving matrix (RM) in IPMF. If the RM is reversible, that means the receiver collects enough information about the original multicast flow, thus can successfully decode and rebuild it.

If due to heterogeneity, a group receiver can only collect P(P<N) sub-flows including coding-sub-flows. Then it only gets a N×P matrix. So there are N variables but less than N equations. If enough variables can be eliminated by Gaussian elimination, we can still decode part of the information, and if the “base sub-flow” can be decoded, then the receiver is still able to enjoy the service in a lower quality.

Potential group receivers can get a copy of the current CM by listening to the auxiliary group. Then the potential receiver is able to determine which N sub-flows including coding-sub-flows it is going to collect, according to its routing table.

After different sink nodes Join news are sent, when occurs collisions, some nodes are possibly activated for the coding sub-source, the original Join for non-coding subgroup may be refused. At this time, the multicast forest structure will be reconstructed in the multicast session. The specific process is divided into two kinds:

One is:

According to each shunt sub-source included in mentioned auxiliary group G′ news, we can determine all the non-coding sub-flow number N, coding sub-flow number M and the coding coefficient matrix formed by the coefficient vector of the M coding sub-flow in the current multicast group G.

Choose N sub-flows and make the matrix formed by coefficient vector of the N sub-flows full rank, the N sub-flows allow to include non-code sub-flow and coding sub-flow;

Send join news to the N shunt sub-source corresponding the N sub-flow to graft corresponding sonsub-tree, receiving the sub-flow packets sent by sub-tree root node.

Another kind is:

After according to each shunt sub-source included in mentioned auxiliary group G′, we can determine all the non-coding sub-flow number N, coding sub-flow number M and the coding coefficient matrix formed by the coefficient vector of the M coding sub-flow in the current multicast group G, the method also includes:

If sink found the connectedness of themselves and can't collect N sub-flows which makes the receiving matrix formed by the N sub-flow coding coefficient vector full rank, thus should choose K sub-flows and make the receiving matrix formed by the K sub-flows encoding coefficient vector can eliminate some elements by Gaussian elimination, decode the top L sub-flows, including L<K<N+M.

The following details two processes:

In the case of collision happened, multicast session has been active for some time. Code parameter matrix CM is no longer unit matrix due to some coding sub-source activated.

In order to collect sub-flow according to priority, first of all we need to design calculation priority methods for coding sub-flow:

1. Assume coding coefficient vector of CSF is: CV_{CSF}=[α₁, α₂, α₃ . . . , α_{N}]^{T}.
2. Let Prioid represents the priority of sub-flow id. It is established in shunt.
3. Pick out all the non-zero elements αᵢ, in CV_{CSF} and form a set CV′_{CSF}={αᵢ_{₁}, αᵢ_{₂}, αᵢ_{₃}}, S≦N.

### 4. Then

$${Prio}_{CSF} = \frac{{\sum }_{j = 1}^{S} {Prio}_{{i}_{j}}}{S} .$$

For example, if CV_{CSF}==[1,0,1,1,0]^{T}, then

$${Prio}_{CSF} = \frac{{Prio}_{1} + {Prio}_{2} + {Prio}_{3}}{3} .$$

Now we can calculate the priority for coding sub-flow. Such as shunt number is 2, the network may appear up to two common sub-flows, a coding sub-flow, the priority order: base-sub-flow, coding-sub-flow, enhancement-sub-flow. Note that the priority of the second uncoded sub-flow is lower than coding sub-flow, it looks like unreasonable, but should consider when shunt number increase, the coding sub-flow with high priority information really should get higher priority.

Shunt number is 2, coding coefficient matrix CM has a simple form, so it is easy to realize.

$$CM = ( \begin{matrix}10 \vert α \\ 01 \vert β\end{matrix} ) .$$

The first kind of algorithm reconstructing IPMF multicast forest structure are described below:

```
for ( each receiver whose Join has been denied )
  {  Listen to the auxiliary group and update the CM
    for  (each sub-flow whose Join has been denied, higher priority first)
      {
        Pick out a coding-sub-flow that satisfies:
      1.  The sub-flow-idth element in its CV is nonzero. Meaning this
        coding-sub-flow contains information about the sub-flow in
        question.
      2.  Higher priority first.
        Send Source-Specific-Join toward the selected coding-sub-source
        }
}
```

The second kind of algorithm reconstructing IPMF multicast forest structure are described below:

```
for (each potential receiver )
    { Listen to the auxiliary group and update the CM
    Pick out N sub-flows including coding-sub-flow from the CM,
    satisfying:
    1.The RM constructed is full rank.
    2.The RM constructed has the highest possible priority
        for (each sub-flow in the RM, higher priority first)
            { int i=1
          While ( i ) //I means the ith best path. For example I = 1 mean
the optimal path.
            {
                if (there are still un-occupied interfaces)
              {  Lookup the corresponding sub-source address in the
              routing table, with the ith best path
              if  (the returned interface in un-occupied)
                  Occupy the interface
              else
                {  If  (i <the number of interfaces)
                  {  i ++ ;
                      CONTINUE;
                      }
                  else
                  {  If  (there're still sub-flows un-selected
                  in the CM )
                    Replace this sub-flow, such that the RM
                    satisfying:
                    1.The RM constructed by CV is full rank
                    2.The RM constructed has the highest possible
                    priority
                    else
                        BREAK
                  }
                }
              }
              else
                BREAK
            }
          }
          //Send ICMP Join, construct multicast distribution structure
    for (all sub-flows that have occupied an interface )
      {  Send Source-Specific-Join with the occupied interface
      }
}
```

Note that the the purpose of the IPMF multicast forest structure algorithm is to build practical, workable distribution structure.

Above algorithm may lead to failure in actual operation process due to its bottom-up model. But the node restart spontaneously that can make algorithm maintain a stable distribution structure. Theoretically, the more shunt number, the better performance of IPMF. However, the more number of shunt, the higher requirement for the forest structure algorithm. On the other hand, compared with the traditional single tree structure of the multicast protocol, as the simulation results show that, even if the shunt is only 2, IPMF still be able to get better throughput than PIM-SM.

FIG. 4 illustrates the IPMF communication, data flow diagram transmits from source to sink, and the specific process is:

Source S is activated, starts generating original multicast data flow whose rate is 2;

Source S chooses SS1 and SS2 as two shunt sub-source, and divides the original multicast data stream into base layer and the enhancement layer for sub-flow SF1 and SF2, the sub-low rate are 1.

Source S sends its address, IPMF address G, sub-source SS1 and SS2 address, the distribution subgroup address and the initial coding coefficient matrix CM (a 2×2 unit matrix) to auxiliary group G′;

The source S will respectively send base layer and enhancement layer to SS1 and SS2 in the unicast way, SS1 and SS2 is not created the corresponding group state and subgroup state.

SS1 and SS2 create the corresponding set of state and subgroup state after receiving the first sub-flow packets, but don't forward this packet, because the output port list in the subgroup state is empty.

If Sink R1, R2, R3 want to join IPMF multicast group G, they should first listen to auxiliary group G′, then get shunt sub-source information, according to the IPMF multicast routing algorithm in the invention case, sink R1 can only collect base layer sub-flow and enjoy the low service quality, but R2 and R3 can collect two sub-flow. So R1 send join message to SS1 through path {R1, C, A, SS1}, R2 send Join message to SS1 through path {R2, C, A, SS1} and to SS2 through path {R2, E, B, SS2}, R3 send Join message to SS1 through path {R3, C, A, SS1} and to SS2 through path {R3, D, CSS1, B, SS2}.

Then the corresponding multicast distribution structure can be established according to the path that join message past, so multicast flow can transmit correctly.

At this time, sink R4 joins group G. It first listens to auxiliary group G″, and sends join message to SS1 according to the IPMF routing algorithm through path {R4, D, CSS1, A, SS1}, sends Join message to SS2 through path {R4, E, B, SS2}.

Note that sub-tree 1 and sub-tree 2 will be in a collision in CSS1 node. When it happens and blocks, CSS1 activates coding sub-source function and generates two random numbers in finite field. The coding coefficient vector is sent to source S in unicast form and multicast deny message to the port in the list of two sub-flow public output port reminding the change to sink. So sink R3 and R4 will receive respectively deny message of sub-flow SS2 and sub-flow SS1.

R3 and R4 restart to listen to auxiliary group, update the coding coefficient matrix CM, get coding sub-source information.

Rerun IPMF multicast routing algorithm.

R3 sends join message to CSS1 through path {R3, D, CSS1}, R3 will receive a original sub-flow SS1 and a coding sub-flow CSS1, thus can decode the original sub-flow SS2.

R4 sends join message to CSS1 through path {R4, D, CSS1}, R4 will receive a original sub-flow SS2 and a coding sub-flow CSS1, thus can decode the original sub-flow SS1.

In the invention example, the application of network coding solves the bottleneck problem generated due to the collision between the sub-flow. By coding to eliminate “the whole route” obstructive influence brought by local bottleneck, as long as coding strategy is appropriate, it can correctly decode the original information at the receiving end.

### Implementation Example 3

FIG. 5 shows the IP multicast data layer distribution system structure diagram about the example 3. It only shows the relevant sections of the example. The system includes source server S, source router DR, shunt son sub-source SS1 and SS2, intermediate node (D, E and C) and sink R.

The source router include:

Set of state build unit, used for receiving the multicast group G original multicast flow sent by the source server S and establishing the (G, S) group state.

Sub-flow generation unit, used for coding original multicast flow for N sub-flows, the integrated information quantity of these N sub-flows is equal to the mentioned original multicast flow, and sink receiving N sub-flows of a subset can reconstruct part of the original multicast flow and obtain certain quality service.

Shunt sub-source determining unit, used for making sure N shunt sub-source for mentioned N sub-flow which is different from sink.

Sub-source multicast unit, used to multicast shunt sub-source information to auxiliary group G′, the shunt sub-source information including multicast group address, source server address, shunt sub-source numbers, shunt sub-source address, shunt sub-source sub-groups address, shunt sub-source coding coefficient matrix.

Sub-flow send unit, used for N sub-flows sent to the shunt sub-source in parallel unicast way, the mentioned source server and the shunt sub-source compose multicast distribution structure of the shunt structure.

The sink include:

Sub-source information acquisition unit, used to send join news to the auxiliary group gathering node RP when the sink need to join a multicast group G, in order to listen to auxiliary group G′ news and get each shunt sub-source information.

Leaf node establishing unit, used for sending a join message to the corresponding shunt sub-source in accordance with shunt sub-source information, join the corresponding the sub-group of shunt sub-source, become the leaf nodes of the corresponding sub-tree.

The shunt sub-source include:

Root node establishing unit, used to create sub-group state and become the root node of each sub-tree after each shunt sub-source receive first sub-flow of source router.

Sub-flow retransmission unit, used for transmitting the received sub-flow to the corresponding port in the output port list of sub-group state, if the port is empty, sub-source send pruning news to the sub-flow input port.

Intermediate node determining unit, used to determine the downstream node in each sub-tree according to the receiving join news, make sure the port of sending join news according to the reverse shortest path, thereby determine its upstream node in each sub-tree, which can determine the various intermediate node of the sub-tree.

Sub-flow transmission unit, used to transmit each sub-flow to sink according to the path of each node in multicast forest structure; multicast distribution trees composed by each shunt sub-source, the intermediate node of each sub-tree and each sub-tree new leaf nodes, the multicast forest structure of multicast data distribution structure composed by each multicast distribution tree.

The intermediate nodes includes:

Coding subtree construction unit, If the overlapping portion between the multicast distribution trees produce congestion, when multicast distribution trees producing congestion in the downstream of congestion nodes have the same leaf nodes, in the congestion nodes network coding used to eliminate congestion and construct coding sub-tree according to the way of building multicast distribution tree from the below of the coding nodes regarding as the root node of coding sub-tree.

The mentioned intermediate node further include:

The first message processing unit, if the intermediate nodes receiving join news already exists corresponding subgroups state, it is stated that intermediate nodes have belonged to a part of the sub-tree described and will join the port receiving Join news in the output port list of the corresponding subgroup state, and create a new branches for the sub-tree.

The second message processing unit, the intermediate nodes receiving join news create subgroup state if without corresponding subgroup state, the port receiving to Join news is joined in the output port list of the corresponding subgroup state and transmits the Join news according to the corresponding shunt sub-source direction, until the Join message arrives the intermediate node or shunt sub-source that already exist in the corresponding subgroup state, the above mentioned intermediate node or shunt sub-source put the port receiving join news into the output port list of the corresponding subgroup state, then complete graft.

The source router further includes:

The port determining unit, When the sink monitor that in auxiliary group the shunt sub-source coding coefficient matrix is unit matrix, the network doesn't encode sub-source, in order to get mentioned forwarding sub-flow optimal port, uses the shunt sub-source address to lookup routing table. The optimal port is got through the reverse shortest path method.

Specific process refer to the method shown in FIG. 2, are not discussed here.

### Implementation Example 4

FIG. 5 shows the IP multicast data layer distribution system structure diagram about the example 4, and it only shows the relevant sections of the example. The system includes source server S, source router DR, shunt son sub-source SS1 and SS2, intermediate node (D, E and C) and sink R, meanwhile the intermediate node is coding sub-source in the example.

The system also includes: coding sub-source, it is one of intermediate nodes, that is C in this example.

The coding sub-source include:

The address sending unit, means that If different join news sent by sink to different shunt sub-source through the same link reach the intersection node, and the above two sub-flow sum of bandwidth is greater than the effective bandwidth of the stated output port, thus the intersection node address is informed to source router in the way of unicast.

The packet storage unit, means that put sub-flow data packet into coding cache in which the public capacity is greater than two packet length.

The source router also include:

Coding coefficient formation and sending unit, means that after receiving intersection node address, source router in a limited field generates two random coding coefficient for two sub-flow which form a coding coefficient vector sent to intersection node in unicast way, so as to make the intersection node activate coding sub-source function, the source router between coding coefficient vector generated by different intersection nodes, and meet linear independence between two vectors;

The coding sub-source also include: coding unit;

The coding unit includes:

Timer setting module, count the interval between the two sub-flow packet real-time respectively, referred to as the first sub-flow packet interval and the second sub-flow packet interval, selecting the smaller recorded as coding flow packet interval which is used to set coding output timer;

Coding module, means that if the timer is overtime, we check the coding cache, if it stores two sub-flow packets which is two sub-flow data packet, it will be coded for coding the sub-flow packets according to the coding coefficient vector, and forward to the corresponding output port;

The first timer reset module, used to recount the code flow packet interval and reset the coding output timer, turn on the coding sub-source function of the intersection node.

Optionally, the coding unit of coding sub-source also include:

The sub-flow forwarding module, If the timer is overtime, we check the coding cache, if in it, there are two sub-flow packets that are from the same sub-flow, the first receiving sub-flow packet will be forwarded directly, or else if the code cache only has a flow packet, thus it will be forwarded directly.

The second timer reset module, used to recount the code flow packet interval and reset the coding output timer.

Optionally, the coding unit of coding sub-source also includes:

The third timer reset module, means that if the timer is overtime, we check the coding cache, if in it, there is not sub-flow packet, reset coding output timer according to the coding flow packet interval calculated in last successful coding or forwarding.

Optionally, the sink also includes:

The sub-flow determining unit, according to each shunt sub-source included in mentioned auxiliary group G′ news, we can determine all the non-coding sub-flow number N, coding sub-flow number M and the coding coefficient matrix formed by the coefficient vector of the M coding sub-flow in the current multicast group G.

The first sub-flow choosing unit, used to choose N sub-flows and make the matrix formed by coefficient vector of the N sub-flows full rank, the N sub-flows allow to include non-code sub-flow and coding sub-flow.

The message sending unit, used to send join news to the N shunt sub-source corresponding the N sub-flow to graft corresponding sonsub-tree, receiving the sub-flow packets sent by sub-tree root node.

Optionally, the sink also includes:

The second sub-flow choosing unit, means that If sink found the connectedness of themselves and can't collect N sub-flows which makes the receiving matrix formed by the N sub-flow coding coefficient vector full rank, thus should choose K sub-flows and make the receiving matrix formed by the K sub-flows encoding coefficient vector can eliminate some elements by Gaussian elimination, decode the top L sub-flows, including L<K<N+M.

Optionally, The auxiliary group G′ uses traditional PIM tree-type multicast distribution structure, holds the only public group address and the only public gathering node RP in the autonomous domain.

Specific process refer to the method shown in FIG. 2, are not discussed here.

The above is only some good examples for the invention, not to limit it, and any modification, equivalent replacement and improvement, etc made for the invention within the spirit and principle, which should be included in the protection of the invention.

What is claimed is:

1. An IP multicast data layer distribution method, comprising:
source router receives the source server S sends the multicast group G original multicast data flow and establish (G, S) group of state entry; coding original multicast data flow for N sub-flows, the integrated information quantity of these N sub-flows is equal to the mentioned original multicast flow, and sink receiving N sub-flows of a subset can reconstruct part of the original multicast flow and obtain certain quality service;
make sure N shunt sub-source for mentioned N sub-flow which is different from sink;
multicast shunt sub-source information to auxiliary group G′, the shunt sub-source information including multicast group address, source server address, shunt sub-source numbers, shunt sub-source address, shunt sub-source sub-groups address, shunt sub-source coding coefficient matrix;
N sub-flows are sent to the shunt sub-source in parallel unicast way, the mentioned source server S and the shunt sub-source compose multicast data distribution structure of the shunt structure;
after each shunt sub-source receive first sub-flow of source router, create sub-group state and become the root node of each sub-tree;
transmit the received sub-flow to the corresponding port in the output port list of sub-group state, if the port is empty, sub-source send pruning news to the sub-flow input port;
when the sink need to join a multicast group G, send join news to the auxiliary group gathering node RP, in order to listen to auxiliary group G′ news and get each shunt sub-source information;
send a join message to the corresponding shunt sub-source in accordance with shunt sub-source information, join the corresponding the sub-group of shunt sub-source, become the leaf nodes of the corresponding sub-tree;
each node according to the receiving join news determine the downstream node in each sub-tree, make sure the port of sending join news according to the reverse shortest path, thereby determine its upstream node in each sub-tree, which can determine the various intermediate node of the sub-tree, multicast distribution trees composed by each shunt sub-source, the intermediate node of each sub-tree and each sub-tree new leaf nodes, the multicast forest structure of multicast data distribution structure composed by each multicast distribution tree; and
if the overlapping portion between the multicast distribution trees produce congestion, when multicast distribution trees producing congestion in the downstream of congestion nodes have the same leaf nodes, in the congestion nodes network coding used to eliminate congestion and construct coding sub-tree according to the way of building multicast distribution tree from the below of the coding nodes regarding as the root node of coding sub-tree; each shunt sub-source transmit each sub-flow to sink according to the path of each node in multicast forest structure.

2. The method of claim 1, wherein each said node according to the receiving join news determine the downstream node in each sub-tree, make sure the port of sending join news according to the reverse shortest path, thereby determine its upstream node in each sub-tree, which can determine the various intermediate node of the sub-tree to be:
if the intermediate nodes receiving join news already exists corresponding subgroups state, it is stated that intermediate nodes have belonged to a part of the sub-tree described and will join the port receiving join news in the output port list of the corresponding subgroup state, and create a new branches for the sub-tree;
the intermediate nodes receiving join news create subgroup state if without corresponding subgroup state, the port receiving to Join news is joined in the output port list of the corresponding subgroup state and transmits the Join news according to the corresponding shunt sub-source direction, until the Join message arrives the intermediate node or shunt sub-source that already exist in the corresponding subgroup state, the above mentioned intermediate node or shunt sub-source put the port receiving join news into the output port list of the corresponding subgroup state, then complete graft.

3. The method of claim 1, wherein before the sink according to above mentioned shunt sub-source send join news to the corresponding shunt sub-source, further including the following steps: when the sink monitor that in auxiliary group the shunt sub-source coding coefficient matrix is unit matrix, the network doesn't encode sub-source, in order to get mentioned forwarding sub-flow optimal port, uses the shunt sub-source address to lookup routing table, the optimal port is got through the reverse shortest path method.

4. The method of claim 3, wherein after sending join news to the corresponding shunt sub-source according to the mentioned shunt sub-source, also including steps:
if different join news sent by sink to different shunt sub-source through the same link reach the intersection node, and the above two sub-flow sum of bandwidth is greater than the effective bandwidth of the stated output port, thus turn on the intersection node's coding sub-source function, make the above two sub-flow network code, the specific process of network coding is:
the intersection node address is informed to source router in the way of unicast;
after receiving intersection node address, source router in a limited field generates two random coding coefficient for two sub-flow which form a coding coefficient vector sent to intersection node in unicast way, so as to make the intersection node activate coding sub-source function, the source router between coding coefficient vector generated by different intersection nodes, and meet linear independence between two vectors;
put sub-flow data packet into coding cache in which the public capacity is greater than two packet length;
count the interval between the two sub-flow packet real-time respectively, referred to as the first sub-flow packet interval and the second sub-flow packet interval, selecting the smaller recorded as coding flow packet interval which is used to set coding output timer;
if the timer is overtime, we check the coding cache, if it stores two sub-flow packets which is two sub-flow data packet, it will be coded for coding the sub-flow packets according to the coding coefficient vector, and forward to the corresponding output port; and
recount the code flow packet interval and reset the coding output timer, turn on the coding sub-source function of the intersection node.

5. The method of claim 4, wherein count the interval between the two sub-flow packet real-time respectively, referred to as the first sub-flow packet interval and the second sub-flow packet interval, selecting the smaller recorded as coding flow packet interval which is used to set coding output timer, also including:
if the timer is overtime, we check the coding cache, if in it, there are two sub-flow packets that are from the same sub-flow, the first receiving sub-flow packet will be forwarded directly;
if the code cache only has a flow packet, thus it will be forwarded directly; and
recount the code flow packet interval and reset the coding output timer.

6. The method of claim 4, wherein count the interval between the two sub-flow packet real-time respectively, referred to as the first sub-flow packet interval and the second sub-flow packet interval, selecting the smaller recorded as coding flow packet interval which is used to set coding output timer, also including: if the timer is overtime, we check the coding cache, if in it, there is not sub-flow packet, reset coding output timer according to the coding flow packet interval calculated in last successful coding or forwarding.

7. The method of claim 1, wherein, after sending join news to the corresponding shunt sub-source according to the mentioned shunt sub-source, also including:
according to each shunt sub-source included in mentioned auxiliary group G′ news, we can determine all the non-coding sub-flow number N, coding sub-flow number M and the coding coefficient matrix formed by the coefficient vector of the M coding sub-flow in the current multicast group G;
choose N sub-flows and make the matrix formed by coefficient vector of the N sub-flows full rank, the N sub-flows allow to include non-code sub-flow and coding sub-flow; and
send join news to the N shunt sub-source corresponding the N sub-flow to graft corresponding sonsub-tree, receiving the sub-flow packets sent by sub-tree root node.

8. The method of claim 7, wherein after according to each shunt sub-source included in mentioned auxiliary group G′, we can determine all the non-coding sub-flow number N, coding sub-flow number M and the coding coefficient matrix formed by the coefficient vector of the M coding sub-flow in the current multicast group G, the method also includes: if sink found the connectedness of themselves and can't collect N sub-flows which makes the receiving matrix formed by the N sub-flow coding coefficient vector full rank, thus should choose K sub-flows and make the receiving matrix formed by the K sub-flows encoding coefficient vector can eliminate some elements by Gaussian elimination, decode the top L sub-flows, including L<K<N+M.

9. The method of claim 1, wherein the auxiliary group G′ uses traditional PIM tree-type multicast distribution structure, holds the only public group address and the only public gathering node RP in the autonomous domain.

10. An IP multicast data layer distribution system, wherein the system contains source server, source router, shunt sub-source, intermediate node and sink;
the source router include:
set of state build unit, used for receiving the multicast group G original multicast flow sent by the source server S and establishing the (G, S) group state;
sub-flow generation unit, used for coding original multicast flow for N sub-flows, the integrated information quantity of these N sub-flows is equal to the mentioned original multicast flow, and sink receiving N sub-flows of a subset can reconstruct part of the original multicast flow and obtain certain quality service;
shunt sub-source determining unit, used for making sure N shunt sub-source for mentioned N sub-flow which is different from sink;
sub-source multicast unit, used to multicast shunt sub-source information to auxiliary group G′, the shunt sub-source information including multicast group address, source server address, shunt sub-source numbers, shunt sub-source address, shunt sub-source sub-groups address, shunt sub-source coding coefficient matrix;
sub-flow send unit, used for N sub-flows sent to the shunt sub-source in parallel unicast way, the mentioned source server and the shunt sub-source compose multicast distribution structure of the shunt structure;
the sink include:
sub-source information acquisition unit, used to send join news to the auxiliary group gathering node RP when the sink need to join a multicast group G, in order to listen to auxiliary group G′ news and get each shunt sub-source information;
leaf node establishing unit, used for sending a join message to the corresponding shunt sub-source in accordance with shunt sub-source information, join the corresponding the sub-group of shunt sub-source, become the leaf nodes of the corresponding sub-tree;
the shunt sub-source include:
root node establishing unit, used to create sub-group state and become the root node of each sub-tree after each shunt sub-source receive first sub-flow of source router;
sub-flow retransmission unit, used for transmitting the received sub-flow to the corresponding port in the output port list of sub-group state, if the port is empty, sub-source send pruning news to the sub-flow input port;
intermediate node determining unit, used to determine the downstream node in each sub-tree according to the receiving join news, make sure the port of sending join news according to the reverse shortest path, thereby determine its upstream node in each sub-tree, which can determine the various intermediate node of the sub-tree; and
sub-flow transmission unit, used to transmit each sub-flow to sink according to the path of each node in multicast forest structure; multicast distribution trees composed by each shunt sub-source, the intermediate node of each sub-tree and each sub-tree new leaf nodes, the multicast forest structure of multicast data distribution structure composed by each multicast distribution tree.

11. The system of claim 10 stated, wherein, the mentioned intermediate node including:
coding subtree construction unit, if the overlapping portion between the multicast distribution trees produce congestion, when multicast distribution trees producing congestion in the downstream of congestion nodes have the same leaf nodes, in the congestion nodes network coding used to eliminate congestion and construct coding sub-tree according to the way of building multicast distribution tree from the below of the coding nodes regarding as the root node of coding sub-tree;
the mentioned intermediate node further include:
the first message processing unit, if the intermediate nodes receiving join news already exists corresponding subgroups state, it is stated that intermediate nodes have belonged to a part of the sub-tree described and will join the port receiving Join news in the output port list of the corresponding subgroup state, and create a new branches for the sub-tree; the second message processing unit, the intermediate nodes receiving join news create subgroup state if without corresponding subgroup state, the port receiving to Join news is joined in the output port list of the corresponding subgroup state and transmits the Join news according to the corresponding shunt sub-source direction, until the Join message arrives the intermediate node or shunt sub-source that already exist in the corresponding subgroup state, the above mentioned intermediate node or shunt sub-source put the port receiving join news into the output port list of the corresponding subgroup state, then complete graft.

12. The system of claim 10, wherein the source router include: the port determining unit, when the sink monitor that in auxiliary group the shunt sub-source coding coefficient matrix is unit matrix, the network doesn't encode sub-source, in order to get mentioned forwarding sub-flow optimal port, uses the shunt sub-source address to lookup routing table, the optimal port is got through the reverse shortest path method.

13. The system of claim 10, wherein the system also includes coding sub-source;
the coding sub-source include:
the address sending unit, means that If different join news sent by sink to different shunt sub-source through the same link reach the intersection node, and the above two sub-flow sum of bandwidth is greater than the effective bandwidth of the stated output port, thus the intersection node address is informed to source router in the way of unicast;
the packet storage unit, means that put sub-flow data packet into coding cache in which the public capacity is greater than two packet length;
the source router also includes:
coding coefficient formation and sending unit, means that after receiving intersection node address, source router in a limited field generates two random coding coefficient for two sub-flow which form a coding coefficient vector sent to intersection node in unicast way, so as to make the intersection node activate coding sub-source function, the source router between coding coefficient vector generated by different intersection nodes, and meet linear independence between two vectors; and
the coding sub-source also include: coding unit;
the coding unit includes:
timer setting module, count the interval between the two sub-flow packet real-time respectively, referred to as the first sub-flow packet interval and the second sub-flow packet interval, selecting the smaller recorded as coding flow packet interval which is used to set coding output timer;
coding module, means that if the timer is overtime, we check the coding cache, if it stores two sub-flow packets which is two sub-flow data packet, it will be coded for coding the sub-flow packets according to the coding coefficient vector, and forward to the corresponding output port;
the first timer reset module, used to recount the code flow packet interval and reset the coding output timer, turn on the coding sub-source function of the intersection node.

14. The system of claim 13, wherein the coding unit of the mentioned coding sub-source also includes:
the sub-flow forwarding module, if the timer is overtime, we check the coding cache, if in it, there are two sub-flow packets that are from the same sub-flow, the first receiving sub-flow packet will be forwarded directly, or else if the code cache only has a flow packet, thus it will be forwarded directly; and
the second timer reset module, used to recount the code flow packet interval and reset the coding output tinier.

15. The system of claim 13, wherein the coding unit of coding sub-source also includes: the third timer reset module, means that if the timer is overtime, we check the coding cache, if in it, there is not sub-flow packet, reset coding output timer according to the coding flow packet interval calculated in last successful coding or forwarding.

16. The system of claim 10, wherein the sink also includes:
the sub-flow determining unit, according to each shunt sub-source included in mentioned auxiliary group G′ news, we can determine all the non-coding sub-flow number N, coding sub-flow number M and the coding coefficient matrix formed by the coefficient vector of the M coding sub-flow in the current multicast group G;
the first sub-flow choosing unit, used to choose N sub-flows and make the matrix formed by coefficient vector of the N sub-flows full rank, the N sub-flows allow to include non-code sub-flow and coding sub-flow;
the message sending unit, used to send join news to the N shunt sub-source corresponding the N sub-flow to graft corresponding sonsub-tree, receiving the sub-flow packets sent by sub-tree root node.

17. The system of claim 10, wherein the sink also includes:
the second sub-flow choosing unit, means that If sink found the connectedness of themselves and can't collect N sub-flows which makes the receiving matrix formed by the N sub-flow coding coefficient vector full rank, thus should choose K sub-flows and make the receiving matrix formed by the K sub-flows encoding coefficient vector can eliminate some elements by Gaussian elimination, decode the top L sub-flows, including L<K<N+M.

18. The system of claim 10, wherein the auxiliary group G′ uses traditional PIM tree-type multicast distribution structure, holds the only public group address and the only public gathering node RP in the autonomous domain.
